(19) United States
(12) Patent Application Publication
(10) Pub. No.: US 2002/0035506 A1
(43) Pub. Date: Mar. 21, 2002

(54) SYSTEM FOR DESIGN AND IMPLEMENTATION OF EMPLOYEE INCENTIVE AND COMPENSATION PROGRAMS FOR BUSINESSES

(76) Inventor: RAMI LOYA, ROCKVILLE, MD (US)

Correspondence Address: LONGACRE & WHITE, 1919 S EADS STREET, SUITE 401, ARLINGTON, VA, 22202

(21) Appl. No.: 09/182,434

(22) Filed: Oct. 30, 1998

(51) Int. Cl. G06F 17/60

(52) U.S. Cl. 705/14; 705/11

(57) ABSTRACT

A system for creating incentive plans to motivate and reward employees includes a series of computer programs or tools which customize, develop, and implement an incentive plan for a variety of businesses. A first tool is a computer program which features an Employee Survey program, which will allow users to customize an employee survey, automate the analysis of the survey, and generate graphic illustrations of the survey results. A second tool is a computer program(s) which performs and enables users to facilitate important functions integral to the design and implementation of an incentive plan, such as, setting-up an Incentive Program, entering Program Data, automating Periodic Benefit Calculations, and generating Employee Benefit Statements, Employee Periodic Reviews, and Periodic Management Reports. The program also provides sample documents of an actual corporate incentive program and of an individual incentive program that a user can modify according to specific needs of a corporation or an individual for virtual immediate implementation and use of a customized incentive plan.

### BACKGROUND OF THE INVENTION

The invention is related to creating incentive and compensation plans to motivate and reward employees and more particularly, a series of computer programs which customize, develop, and implement an incentive and compensation plans for a variety of businesses.

Companies and businesses are continuously looking for ways to maintain and improve their leadership, edge out the competition, and develop innovative products which set them apart from others. Key to success and survival of most organizations is their most valuable asset, their employees. In order to unite employees under a common goal and to instill creativity, self-drive and empowerment, efficiency and productivity, many business look to incentive plans which motivate and reward employees with cash or non-cash bonuses.

Accordingly, it is an object of the invention for a mechanism to provide an approach and method for creating such incentive and compensation plans effectively for most types of organizations.

It is another object of the invention to provide an effective mechanism for management of any business to create a self-motivated work force and ensure long term success of their organization.

It is another object of the invention to provide tools for expediting, implementing and administering such incentive programs.

It is yet another object of the invention provide a mechanism for saving a business time, money and effort in the endeavor of creating an incentive plan.

It is a further object of the invention to provide a computer program which facilitates the design of an incentive plan that sets goals and objectives, measures performance, calculates employee bonuses and creates reports based on periodic performance results, and provides plan monitoring and feedback capabilities.

It is a specific object of the invention to provide a series of computer programs which collectively allow a general incentive plan and a general compensation plan to be customized for a particular business based on employee surveys, incentive factors, profit allocations, and other factors critical to the success of the particular business.

### SUMMARY OF THE INVENTION

The invention is a system for design and implementation of an employee incentive and compensation plan for a business. A series of computer programs enables a user of the programs to modify preset structures of the computer programs according to parameters determined by the user. The preset structures include an Employee Group structure, Incentive Factor Score Table structures, a Factor Percent Allocation of Incentive Factors to Employee Groups structure, and a Profit Allocation to Employee Groups structure. The series of computer programs accept data input from the user and generate outputs based on the preset structures and periodic data input, the outputs including periodic employee bonuses.

Parameters are determined by the user and include Employee Groups, Compensation Schedule Incentive Factors, Factor Percent Allocations, and Profit Allocations. Data input from the user includes employee data and business performance data. Incentive Factor Score Table structures include increments of a set goal or rating and an associated score for each increment (or for each level of goal achieved).

The invention features computer software system for an automated employee incentive plan, including a first software tool having for incentive plan design and implementation. This first tool enables functions to be performed by a system user including setting up an incentive program, entering program data, and automating periodic employee bonus calculations based on the incentive program and program data.

The invention also includes a second software tool having a surveying program for generating an employee survey from a preset questionnaire structure. The second software tool compiles, analyzes, and outputs results gathered by the employee survey. One complied result is a Survey Index which allows for comparison of an initial employee survey with a successive employee survey.

The first software tool includes structures for setting up the incentive program, including an Employee Group structure, Incentive Factor Score Table structures, a Factor Percent Allocation of Incentive Factors to Employee Groups structure, and a Profit Allocation to Employee Groups structure. The structures are adapted to be customized by the user. The first software tool integrates program data with the structures to generate the periodic employee bonus calculations.

The first software tool further analyzes, compiles and outputs the program data and the periodic employee bonus calculations.

From the description provided below, it will become apparent that the present invention provides numerous benefits over prior benefit systems. For example, incentive rewards are directly linked to the financial performance of the organization. It is calculated as a percentage of one or several of financial benchmarks, including but not limited to pretax profits, gross profit dollars earned, sales dollars, increase in sales dollars, increase in profit dollars, economic value added (EVA), earnings per share (EPS), etc. Additionally, each participant is assigned a piece of the total award pie depending on the importance of their role and contribution to the organization. The invention creates main employee groups and subgroups from your organization chart or build special teams assigned to specific tasks or projects. Incentive factors are tools or means through which the organization can achieve its long term strategic goals. They are identified by closely reviewing the long term goals and determining the most critical elements essential to achieving them. Employee groups, teams, and individuals are compared to the incentive factors selected and are assigned the ones they have the most influence and impact on. Each factor assigned is then designated a weight based on its importance within the group in relation to reaching the set goals. Goal attainment is measured by comparing actual periodic results to the set goals. Measurements are made at all levels of the corporate structure. For each group a regular payout schedule can be selected from bi-weekly to monthly, quarterly, semi-annually, or annually. Corporate executives, department managers, and supervisors have instant access to all the performance and incentive compensation data for the groups which fall under their corporate responsibility.

The invention ensures that participants can only review the data designated as accessible to them and cannot access other program confidential parameters or data. All calculations related to incentive payout are fully automated. Detailed performance, incentive pay statements and reports are easily generated for individuals, teams, groups, or the whole company. Managers and supervisors can conduct reviews face to face on-line with their group members. They review personal performance, goal attainment, incentive reward and receive feedback from their members on areas that need improvement, suggestions on how to improve productivity and enhance profitability.

These and other features of the invention will become apparent to those skilled in the art when taken in connection with the following description and drawings.

### BRIEF DESCRIPTION OF THE DRAWING

FIG. 1 is a sample employee survey according to the invention;

FIG. 2 shows a sample of a company's employee group structure;

FIG. 3 shows an employee survey sample tabulated according to the invention;

FIG. 4 is a flowchart of the incentive plan design and implementation process according to the invention;

FIG. 5 is a score table according to the invention;

FIG. 6 is a table showing allocation of incentive factors to employee groups according to the invention;

FIG. 7 is a table demonstrating an example of a profit allocation method according to the invention;

FIG. 8 is an example of an evaluation and bonus calculation statement according to the invention; and

FIG. 9 is an example of an evaluation and bonus calculation statement according to the invention.

FIG. 10 shows a flow chart of the set-up process of this invention.

FIGS. 11a-11e show examples of setup reports for a sample sales group.

FIG. 12 is an employee report for the sales group.

FIGS. 13a-13d show examples of company summary reports including a company bonus report, a compensation source allocation report, a company financial data report (monthly), and a long-term goals report.

FIGS. 14a-14b show examples of group summary reports including a group bonus summary report and a factor goals/actual values report provided by the present invention.

FIGS. 15a-15e show examples of employee bonus reports including employee evaluations, employee personal objectives report, an employee bonus calculation report, a bonus authorization and history report, and a combined report.

FIG. 16 shows examples of various allocation charts.

### DETAILED DESCRIPTION OF THE INVENTION

The invention is a collection of computer programs which provide unique tools to the user, such as management of a company, which are beneficial to expediting implementation of an incentive compensation program which can be custom designed for a particular company.

The basis for the incentive plan according to the invention is that an employee's incentive for compensation is directly related to certain financial benchmarks or compensation sources.

The first tool is a computer program which features an Employee Survey program, which will allow users to customize an employee survey, automate the analysis of the survey, and generate graphic illustrations of the survey results. Although preferred as a part of the present invention, the survey may be omitted without affecting the essential features of the present invention.

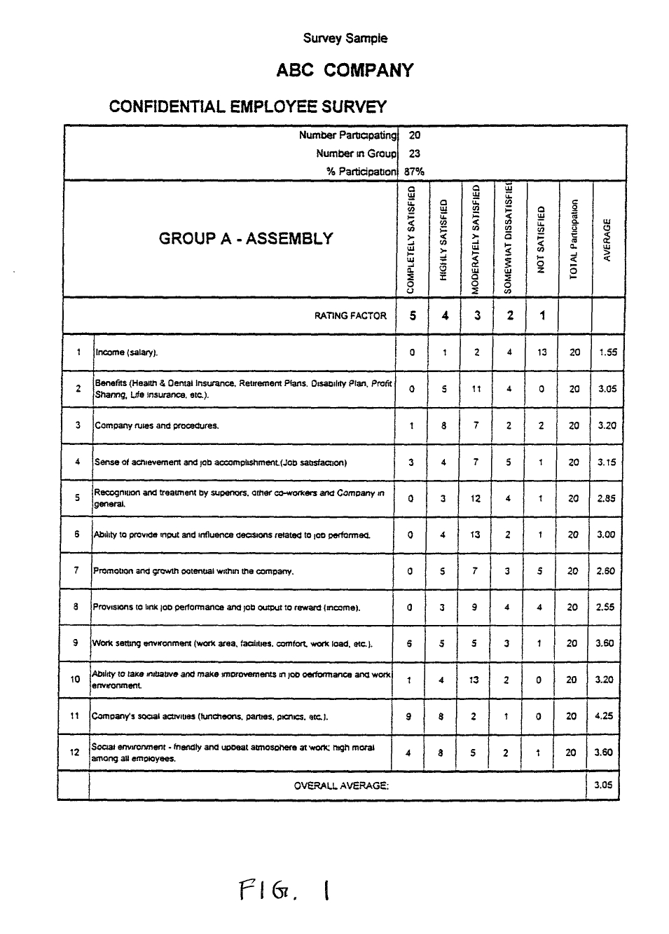

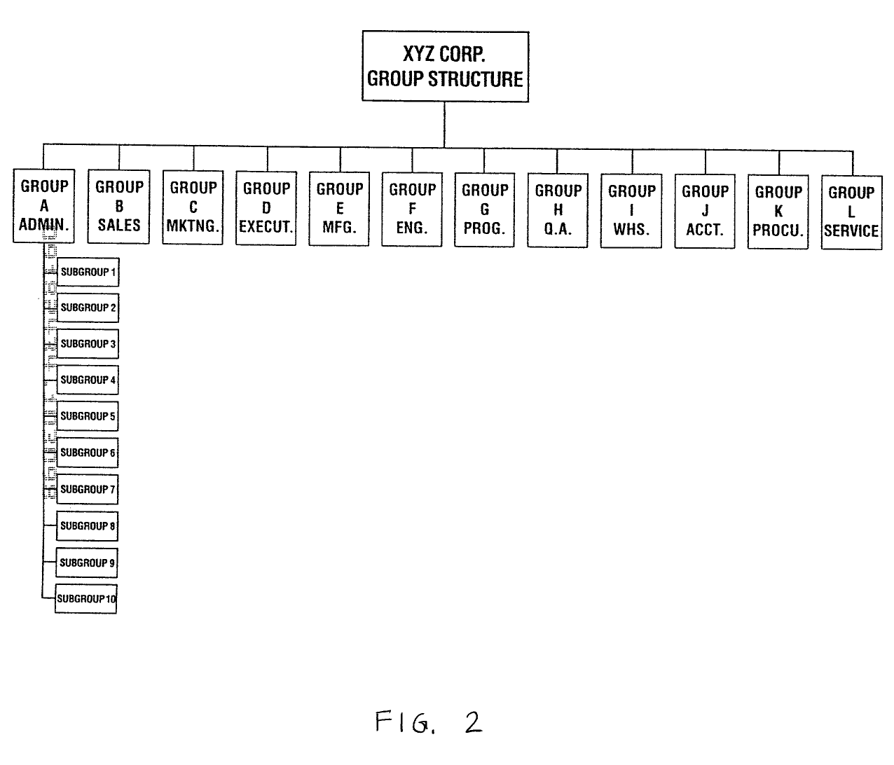

Key to the development of the incentive plan is the Employee Survey. A questionnaire is provided by the first tool which determines several important factors: Motivating an demotivating factors affecting the performance of the company's workforce; Satisfaction and moral levels amongst employees; and Areas needing improvements in service and support to employees. A sample Employee Survey is shown in FIG. 1. Employees are divided into several main groups of similar job function and working conditions and environment. A sample of a company's employee group structure is shown in FIG. 2. The survey is critical to assessing the company's performance as viewed by the workforce, and providing feedback to management for what is important to the company's success from the employees' perspective. This information is very useful when designing a custom incentive plan.

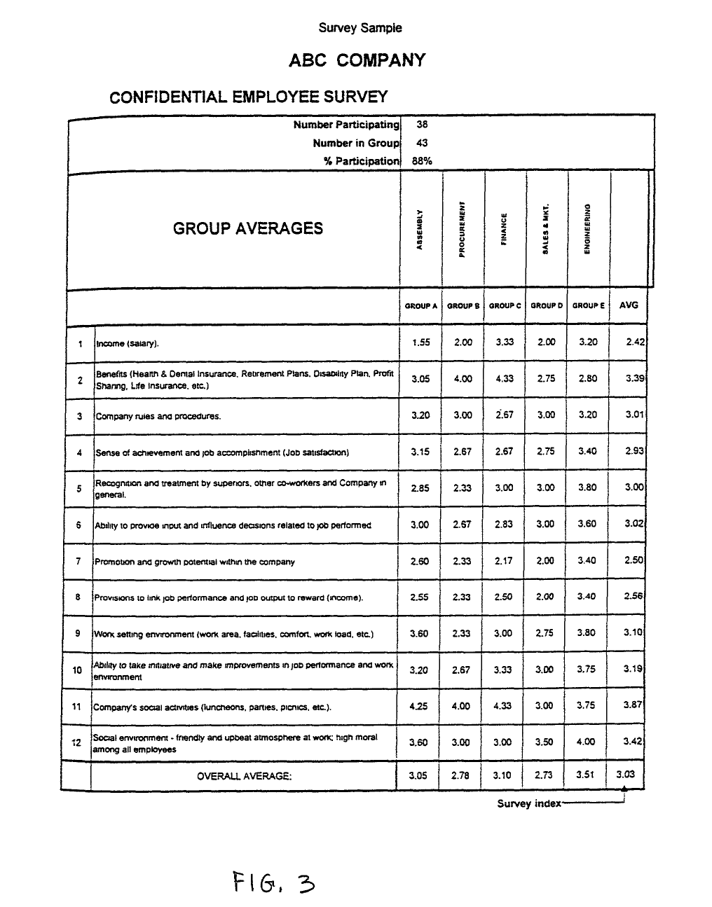

The Employee Survey program allows a company to design a survey format to match their specific needs. A general survey is provided in the program according to the invention. Questions can be added or deleted to customize the survey. The program generates the customized questionnaire, compiles and tabulates the results in an automated spreadsheet, and provides graphic output charts depicting the results, as specified, and as shown in FIG. 3. Additionally, a numeric “Survey Index” is automatically generated by the program which is used for comparative purposes in future surveys. The “Survey Index” is an overall company average survey score based on the rating system of rating factors ranging from 5=completely satisfied to 1=not satisfied, such as in the illustrated examples of FIGS. 1 and 3. A successful incentive plan will be reflected in an increased “Survey Index” in a successive survey, indicating improvements in the areas targeted by the questionnaire. The survey program provides details for conducting the survey successfully, including explaining the survey, providing instruction for completion of the survey, incentives for achieving high employee participation in the survey, etc.

The second tool is a computer program(s) which performs and enables users to facilitate important functions integral to the design and implementation of an incentive plan, such as, setting-up an Incentive Program, entering Program Data, automating Periodic Benefit Calculations, and generating Employee Benefit Statements, Employee Periodic Reviews, and Periodic Management Reports.

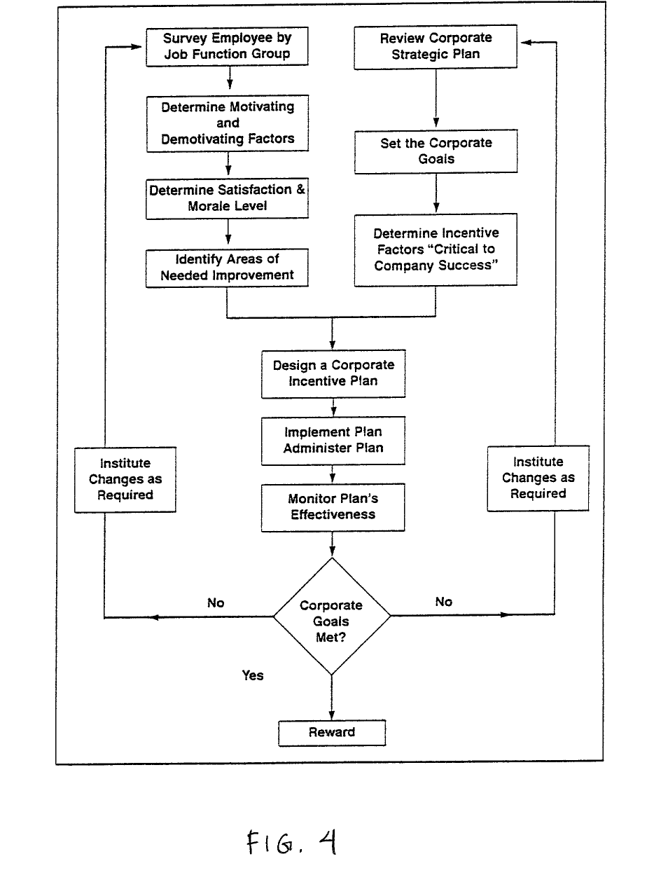

The second tool enables incentive plan design and implementation. A flow chart of the process of designing and implementing an employee incentive plan in an organizational setting is shown in FIG. 4, and is an instrumental aid in connection with the second tool according to the invention. The program is accompanied by detailed instructions and aids such as the flowchart to ensure an organization's success in the process of the design and implementation of the incentive plan.

Steps in the process include setting the corporate goals, surveying employees, determining incentive factors, determining allocation of incentive factors to employee groups, and determination of profit allocation. The latter three steps are included in the Design step shown in FIG. 4. The plan is based on the principle that employees are provided with periodic bonuses based on three key factors: Company Profit, Meeting Corporate Goals, and Individual Employee Performance. Corporate and individual goals can be set on an annual, quarterly or monthly basis and revised during the year as necessary. The company will measure the company and individual performance of the employees on a periodic basis. Then the company rewards the employees depending on the quarterly measured results as they relate to that specific period.

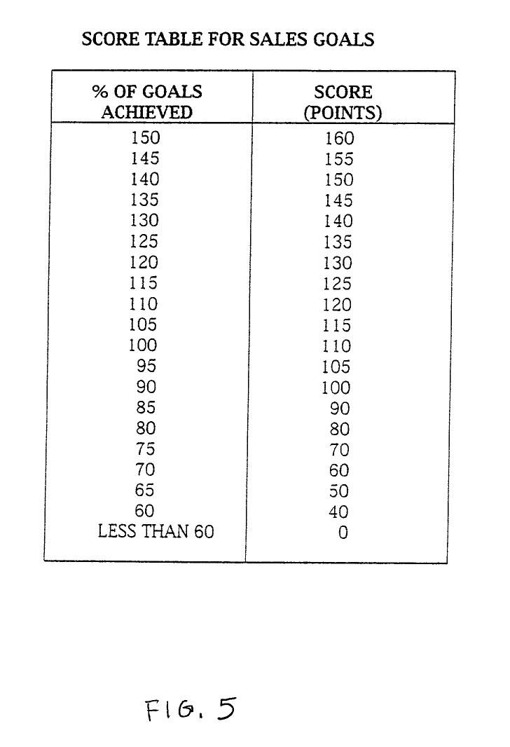

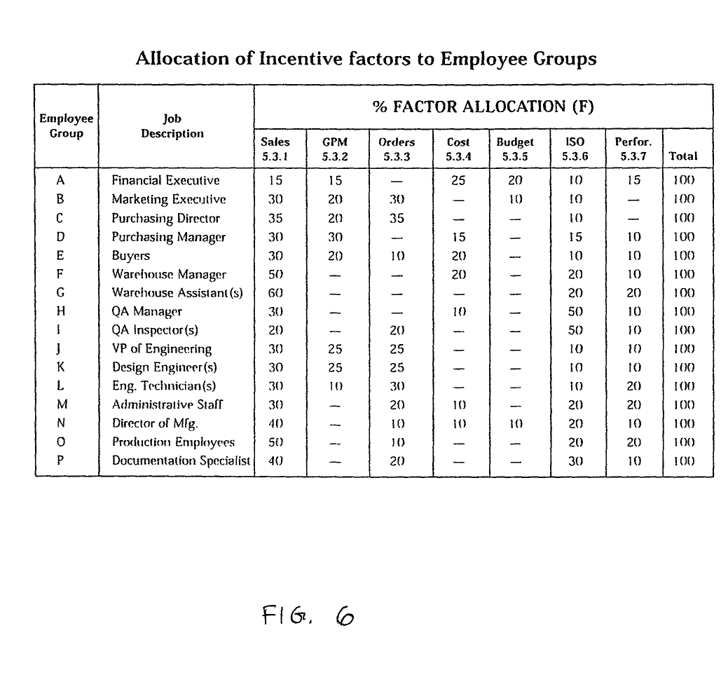

Typical incentive factors provided in the program for designing the incentive plan include Achieving Corporate Sales Goals, Improving Gross Profit Margin, Booking New Sales Orders, Cost Reduction Efforts, Controlling Budget, Personal Objectives and Personal Performance. Incentive Factors vary from company to company and industry to industry so the program allows for each company to select its own Incentive Factors and customize the incentive plan to fit their needs. Other examples of Incentive Factors which may be selected in the program include Improving Customer Satisfaction, Increasing Production Yield, Increasing Market Share, etc. Once the Incentive Factors are determined, scores are assigned for each level of percent of the goals achieved. For example with Corporate Sales Goals, at the end of every quarter, actual sales figures are compared to the goals and percent of goals can be determined. An example of a Score Table for sales goals is shown in FIG. 5. In this table an employee receives a score of one hundred points if they reach 90% of the goal. The score is higher as higher percentages of goals are reached and vice versa. The particular incremental measurements can be varied as required and set within the Score Tables provided by the second tool according to the invention. Score levels are totally flexible and can be set according to each company's needs.

Job Performance can be measured by assigning points between 5 and 1 with 5=Excellent and 1=Unacceptable for a number of preselected elements important to Job Performance, such as Attendance, Motivation, Efficiency, etc. This will allow the highest performance rating of 50, and scores, such as determined in the Corporate Sales example of FIG. 5, can be assigned for increments of the points scored by the employee's performance rating, and tabulated.

The program provides Score Tables for each of the Incentive Factors set by the company user of the program, and the once scores are assigned for each increment of the percentage of the goal reached, the program relies on simple data entry to calculate scores for employees, based on the three key factors of the incentive plan, as will be described hereinafter.

The next step in the process of designing the incentive plan is determining allocation of incentive factors to employee groups. Each Employee Group (FIG. 2) which has been structured within the program, is compared to the Incentive Factors and the potential influence and impact by each group is determined. Not all Incentive Factors are assigned to every group. Each Employee Group is designated a Factor Percentage Allocation for the Incentive Factors allocated to it. Factor Percentage Allocation is based on the importance the Incentive Factors play within a group in relation to reaching the set goals. The total percentage allocated for each Incentive Factor per Employee Group should be 100%. FIG. 6 shows a table of Allocation of Incentive Factors to Employee Groups. The program generates the table based on the Score Tables entered into the program and the data entry of the Factor Percentage Allocation data.

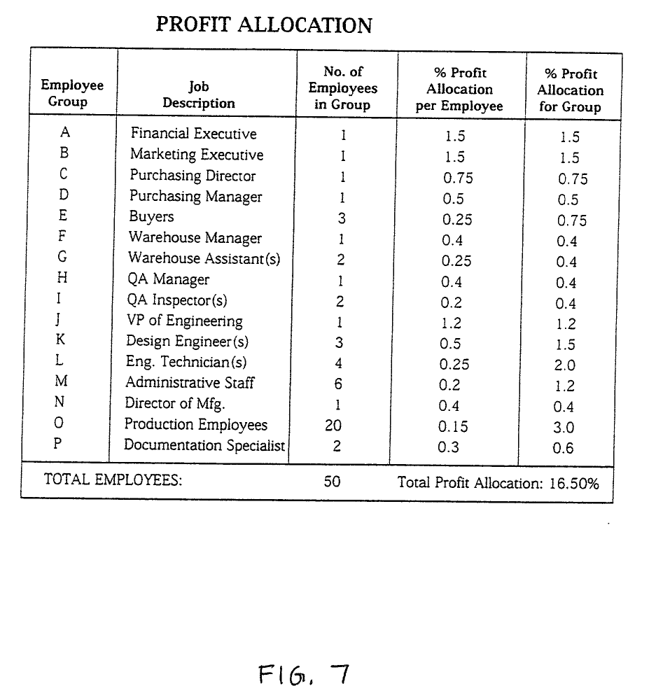

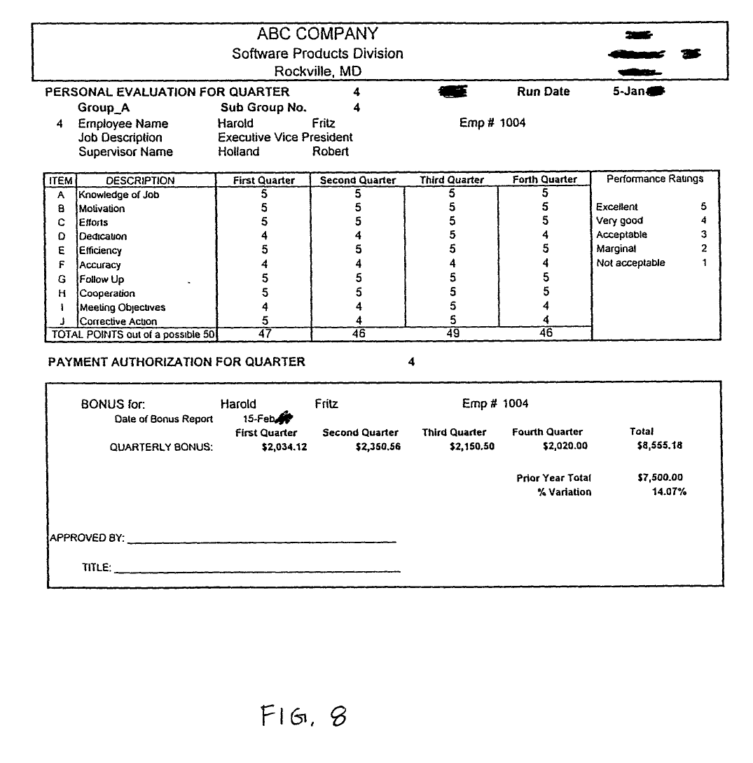

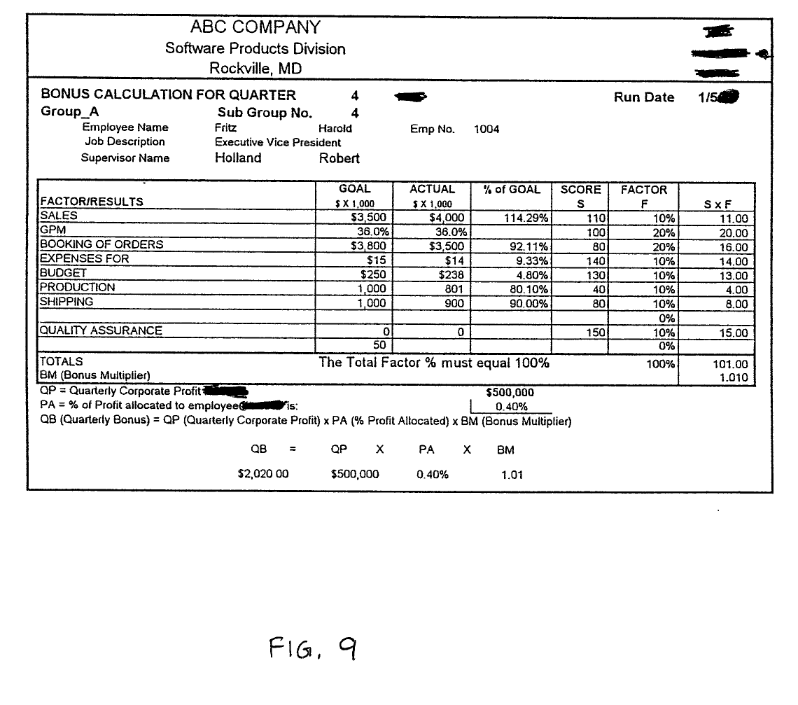

The last step in the design of the incentive plan is determining the profit allocation. Profit Allocation is defined as the percentage of one or more compensation sources allocated to each employee or Employee Group by the company. This is a key element in determining the quarterly bonus amount each employee will receive. The determination of percentage allocation is made according to the amount of contribution and importance of the employee or Employee Group in generating company profit. The larger the contribution and importance of the group or individual, the larger their profit allocation will be. First the company determines the percentage of the profit it is wiling to allocate to the incentive plan, for example, a minimum can be within a range of 10% to a very generous maximum of 50% of company profit. FIG. 7 shows Profit Allocation for a company of 50 employees, with a total profit allocation of 16.50% to the plan. Compensation can be linked to several compensation sources which can be allocated rather than just linked to pre-tax profits.

The program performs the bonus calculation method according to employee score in each category of Incentive Factors and the percent of each compensation source to each employee. The employee score is multiplied by the % factor allocated to the Incentive Factor category and then divided by 100. Adding all category scores yields a Bonus Multiplier (BM). The Bonus Multiplier is derived using the following formula:

| BM | S1 × F1 | S2 × P2 | S3 × F3 | Sₙ × Fₙ |
|---|---|---|---|---|
| Bonus Multiplier | 100 | 100 | 100 | 100 |

S1, S2, S3, . . . , etc are scores achieved for each incentive factor, and F1, F2, F3, . . . , etc. are % factors allocated to the above scores respectively. Note that F1+F2+F3+ . . . +Fₙ=100%.

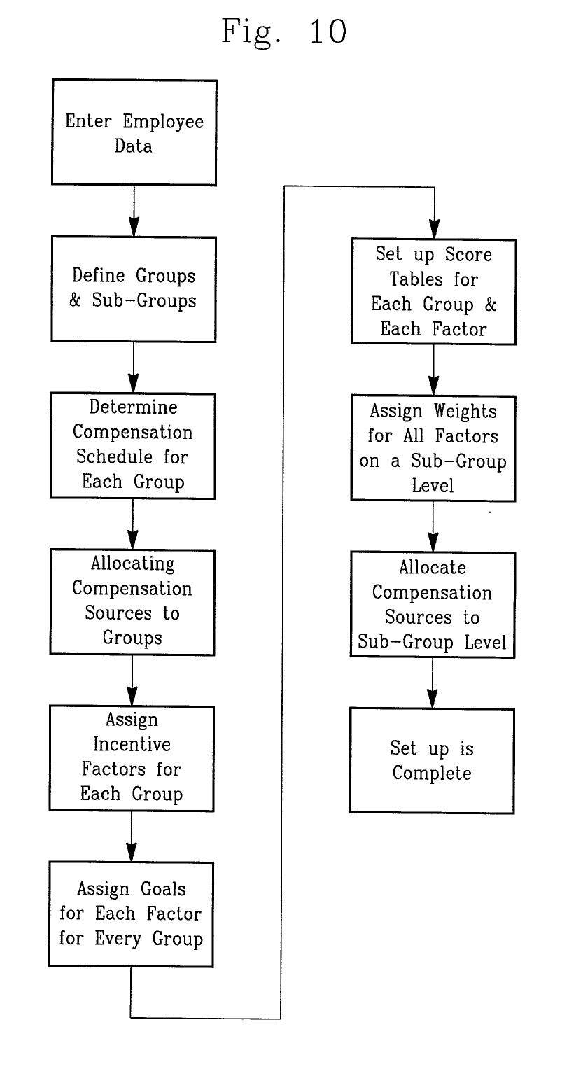

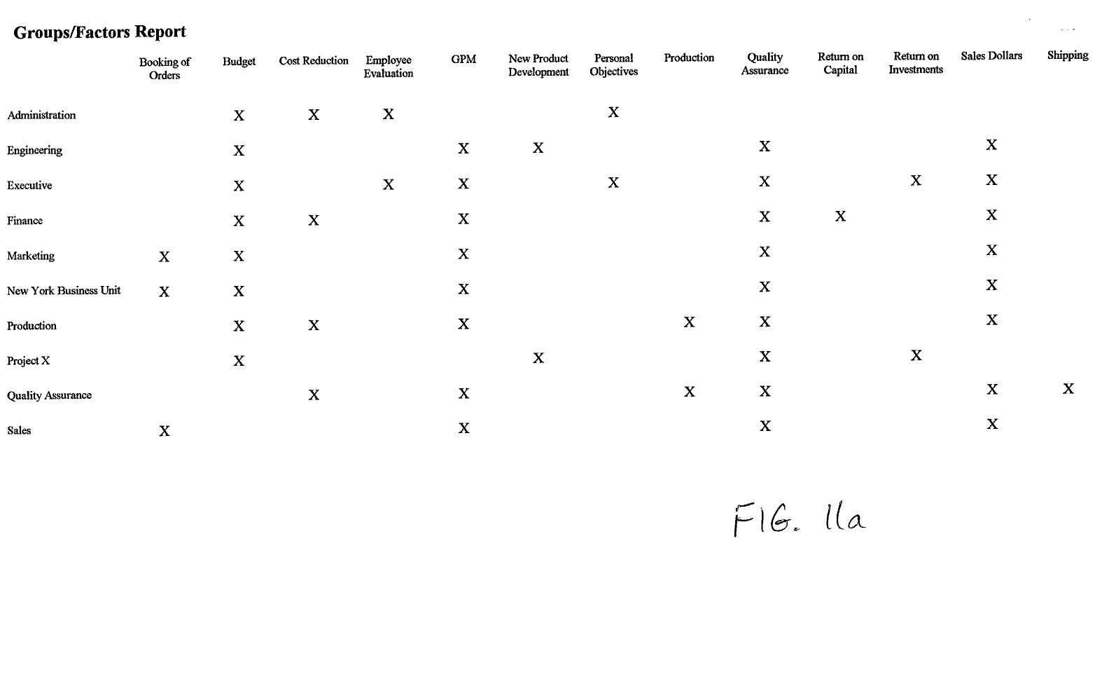

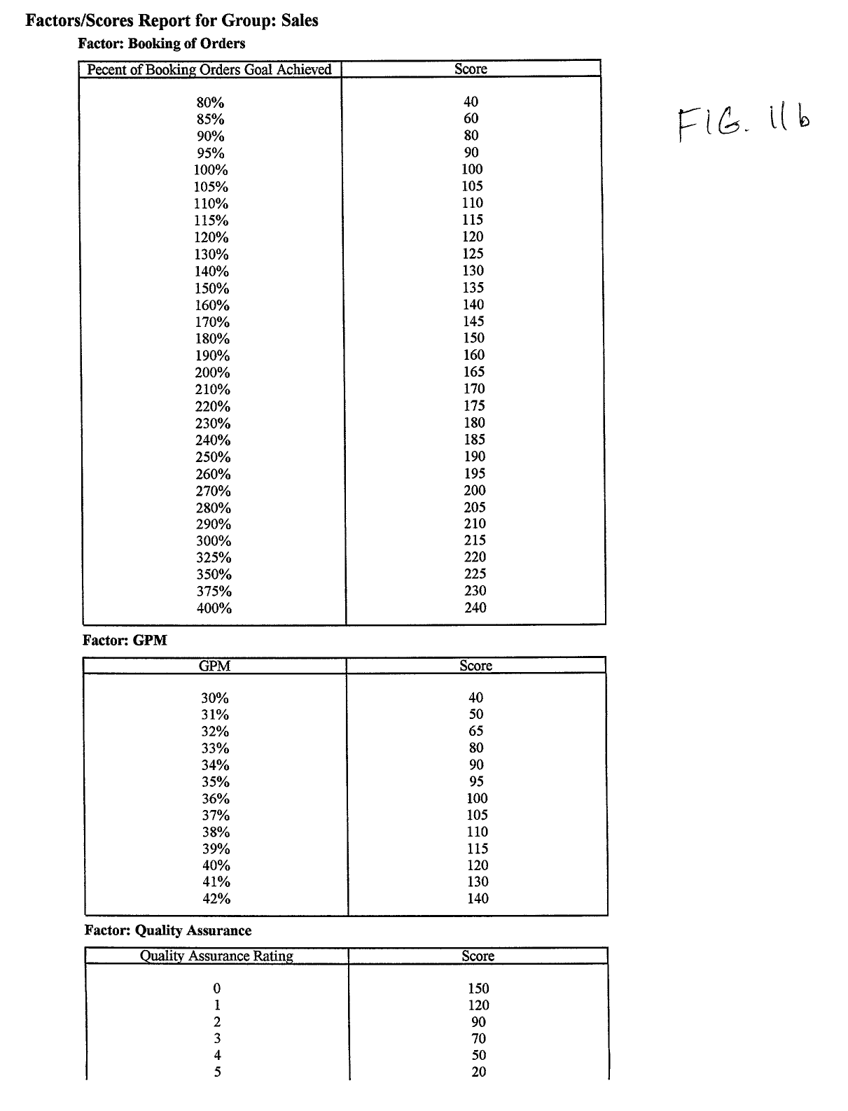

The final quarterly bonus (QB) for each employee is calculated by QB=QP (Quarterly Company Profit)×PA (% of Profits Allocated to Employee)×BM (Bonus Multiplier). The program performs all calculations automatically to speed and simplify the bonus calculation process. Periodic statements for each employee are generated by the program based on cumulative year to date figures. FIGS. 8 and 9 show samples of quarterly statements summarizing performance, scores and bonus calculations.

The implementation of the incentive plan includes management meetings, company wide meetings, employee group meetings, plan administration, monitoring and feedback, and quarterly management review. These steps in collaboration with the incentive plan provided by the first and second tools of the program system ensure the success of the incentive plan within the company. The program generates periodic and year to date reports for management review to allow for assessment of progress and incentive plan success. Statistical data and graphic displays can be generated for a multitude of data, as needed. The incentive plan can be modified to account for necessary adjustments based on the periodic reports. The program allows for total flexibility for adjustments to allow for quick implementation of changes. For example, the originally designated percentage allocated for a particular Incentive Factor can be changed, added or removed if it is ineffective due to misjudgment or changing conditions, as long as the total allocation remains at 100%. Score Tables offer total flexibility in adjusting compensation amounts. Modification to the originally designated Incentive Factors, Employee Groups, Percent Profit Allocation, or any other figures can be easily modified as will be understood by those skilled in the art.

The program also provides sample documents of an actual corporate incentive program and of an individual incentive program that a user can modify according to specific needs of a corporation or an individual for virtual immediate implementation and use of a customized incentive plan. The samples provide examples of the features as described in connection with the second tool, in user ready format, including spreadsheets for Employee Group structures, Score Tables for preset Incentive Factors, Percent Factor Allocation tables to Employee Groups, Profit Allocation tables, automated bonus calculation means, and formatted output reports and summaries of the above. These program features can be easily modified to meet the specific needs of the user, as will be understood by those skilled in the art.

One of the most unique features of this invention is the set-up process as well as the report writing process.

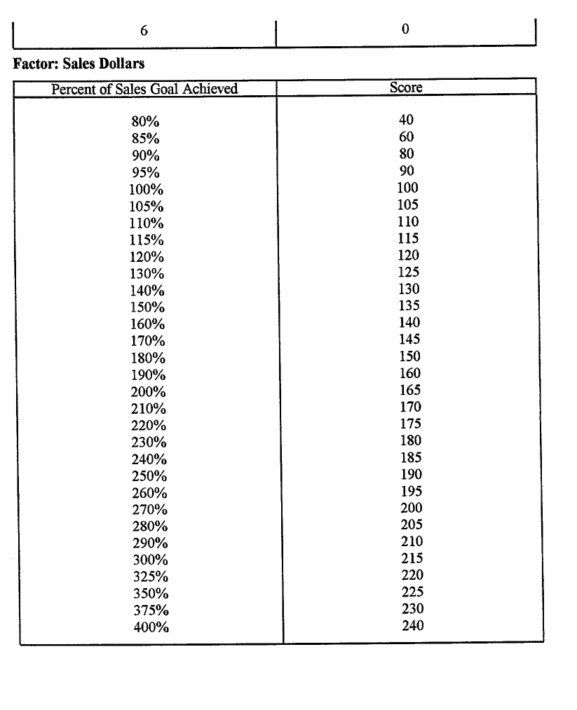

FIG. 10 shows a flow chart of the set-up process of this invention.

At the system administrator stage, the user designates the year, inputs security privileges for new users including passwords, and sets the archive information.

At the library stage, the user inputs the groups and subgroups, the compensation sources, the incentive factors, the evaluation categories, and the employee objectives. The libraries store standard lists of information within the database. This data is used in other sections of the program. Library alterations will affect the appearance and (in some cases) the use of this data throughout the program. In any library, a User with Group Administrator privileges may only edit records that he/she has created. Records created by the System Manager or other Group Administrators may not be edited. Also, records being used by other Group Administrators or the System Manager may not be deleted.

In the groups/subgroups procedure, you define the smaller structures contained within the group structures. Groups and subgroups don't have to be an exact representation of your company's structure. They can also represent projects, teams, separate business units, or other organizations within the company. Only Users with System Manager privileges may establish groups.

The compensation sources library contains a list of the available compensation sources. Compensation sources are monetary sources from which compensation payments are derived. Once defined, they can be allocated or divided up between different groups and subgroups. This invention provides an optional predefined compensation source, Earnings Per Share, which functions differently than any User defined source. This source is distributed to employees as shares and is not divided up and allocated like other sources. In the library, this cannot be changed, altered or deleted. (This does not mean, however, that it must be used-it is simply a built in feature of the program that cannot be altered). User defined compensation sources can be any measurable monetary source.

The factors library contains a list of possible incentive factors which may be used to measure your company's performance and affect compensation calculations. Once defined, factors may later by assigned to groups and allocated to subgroups. This invention provides two special, predefined factors, Employee Evaluation and Employee Objectives. Both of these are supported by separate sections of the invention. In the factors library, they cannot be altered or deleted. All factors evaluate in some way to determine a score, which is then used in calculating compensation payments. In most cases, a goal is involved, which is set in another section of the invention. User defined factors can be defined as one of seven basic types, indicating what type of value the factor represents and how it is measured:

Percent—a direct measures of some percentage value. An example is GPM.

Percent of Goal Achieved—measures an increase of monetary value from a set goal. An example is profit dollars. The measurement would be the percentage of profit dollars achieved in excess of the goal.

Percent Decrease from Goal—measures a decrease of monetary value from a set goal. An example is the company's budget. The measurement being the percent decrease in the budget from the goal.

Units—a direct measurement of some unit value. An example is a rating or count of some kind.

Units Above Goal—measurements a unit value in excess of a set goal. An example is production above quota. The measurement being the amount of production that exceeds a given goal.

Units Under Goal—factors are measurements of a unit value achieved under a set goal.

Percent of Unit Goal Achieved—factors measure a percent increase of some unit value from a set goal. This type of factor might be used to measure the percent increase in production.

Employee evaluation categories are criteria used to measure an employee's performance. These categories are used only when they are allocated to certain groups where the employee evaluation features of the program are used. Evaluation categories are selected on an individual basis.

Employee objectives are goals or tasks set for employees on an individual basis. The employee objectives library contains a standard list of these which you can modify or add on to. This library only needs to be used if you plan to use the employee objectives functions of the program.

For each objective you may define a default difficulty level. This measures the relative amount of difficulty involved in completing the task. The difficulty level may be modified for each individual when objectives are actually assigned.

Once the necessary information has been entered into the libraries section, the user proceeds to the Group Setup section. In the Group Setup section, the user defines the main group structures that are contained within the organization. Main groups are then subdivided into subgroups which can be selected from the subgroups library. Groups and subgroups can be assigned supervisors. Employees within a subgroup can also be allocated a certain number of phantom EPS shares. If phantom shares are indicated for a subgroup, employees in the subgroup will automatically receive (as part of their allocated compensation) the number of shares allocated to them times an EPS share price.

Next, the user moves to the employee section. The employee section contains all information pertaining to the employees included in your compensation plan. This program allows you to record employee names, IDs, addresses, phone numbers, hired and termination dates, as well as which group and subgroup that employee belongs to.

Next, the user moves to enter the incentive factors for each group/subgroup and employee. This section is divided into the factors section, the factor goals section, and the long-term goals section.

In the factors section, the user selects which factors will have an effect on which groups in your company. Factors selected for a particular group will become measurement tools for it, allowing you to set goals and record various aspects of your company's performance to determine that group's compensation.

The factor goals section allows the user to set goals for the factors you have designated for each group. Goals serve several purposes: they determine (and show your employees) what is expected to be achieved for a given time period, and they are also integral components in how the program's calculations are derived. Each factor uses the goals you set along with actual results to determine scores for each period.

The long-term goals section lets the user define yearly, long-term goals for both factors and compensation sources. All established factors and compensation sources can be given long-term forecasts. Long-term goals are not used directly in compensation calculations, rather they are for reference.

Scores are the end result of the program's calculations involving factor goals and actual results. They are normalized measurements that are used to determine how much allocated compensation will actually be given to an employee. An employee score of 100 for a factor, generally indicates the employee will receive 100% of the compensation allocated for that factor. A lower score will give the employee less and a higher score will give the employee more. The scores section includes score tables and personal objective score adjustments.

In the score tables, the translation from a factor's performance measurement to a normalized score value is done by use of User-defined score tables. Score tables are lookup tables. The program determines the score to use in calculating an employee's compensation by comparing a factor's goal with the factor's actual results and looking the result up on the appropriate score table.

In the personal objective score adjustments, the translation from a factor's performance measurement to a normalized score value is done by use of User-defined score tables. Score tables are lookup tables. The program determines the score to use in calculating an employee's compensation by comparing an objective's goal with the objective's actual results and looking the results up on the appropriate score table.

For the employee evaluation, both of the invention's special factors (Employee Evaluation Categories and Employ Objectives) have their own setup and data-entry sections. The calculations and scores for these factors are determined separately from any other factors in the program. The employee evaluation categories section allows the user to define how individual employees are rated during the year. For each employee you can define a list of rating categories (selected from the categories library or tailored specifically for each employee). Each category is also assigned a weight value, determining its relative importance in the evaluation. The employee objectives section allows the user to define individual employee objectives for a compensation period. For each employee the user can set a list of objectives (selected from the objectives library or tailored specifically for each employee). Each objective is also assigned a difficulty level, and a weight value to determine its relative importance in the evaluation. In addition, each objective may be assigned a priority level and due date for reference purposes.

The company compensation allocation dialogue of this invention allows the user to enter/edit and review the allocation of compensation. The program displays compensation allocation by three methods: 1) the percentage of all incentive factors allocated to a subgroup, 2) the percentage of all compensation sources assigned to all subgroups within a group; and , 3) the percentage allocation of a compensation source to a subgroup and the employees belonging to the subgroup.

Data entry functions are performed by the group administrator or users with data entry clearance. The data section includes a calculation data menu, a factor data function, an employee evaluation section, and a checklist of completed objectives.

The calculation data menu allows for the input of actual financial data for compensation sources. The factor data dialogue allows for the input of actual data for incentive factors. The employee evaluation menu provides the capability to enter actual scores against employee evaluation criteria. And, the system also provides a system to track completed objectives and tasks designated for an employee or group.

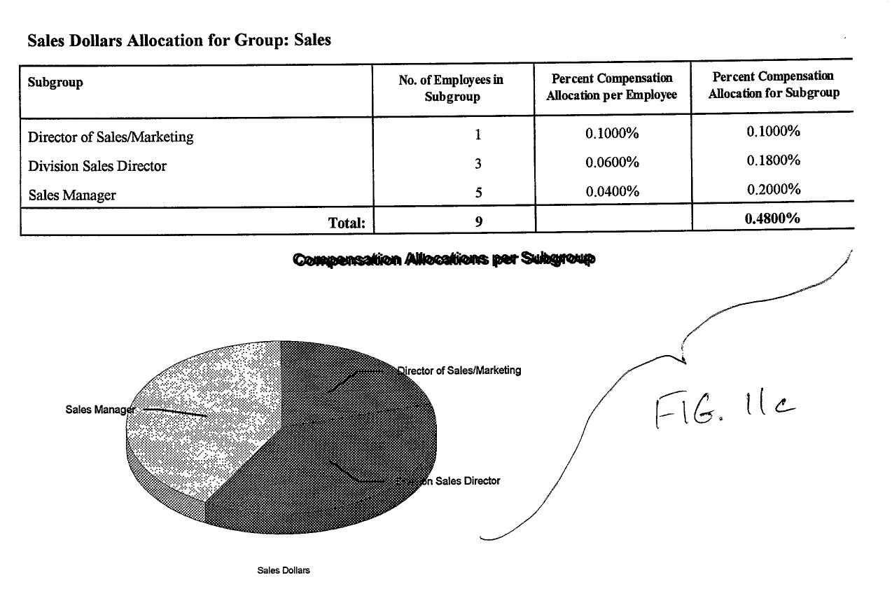

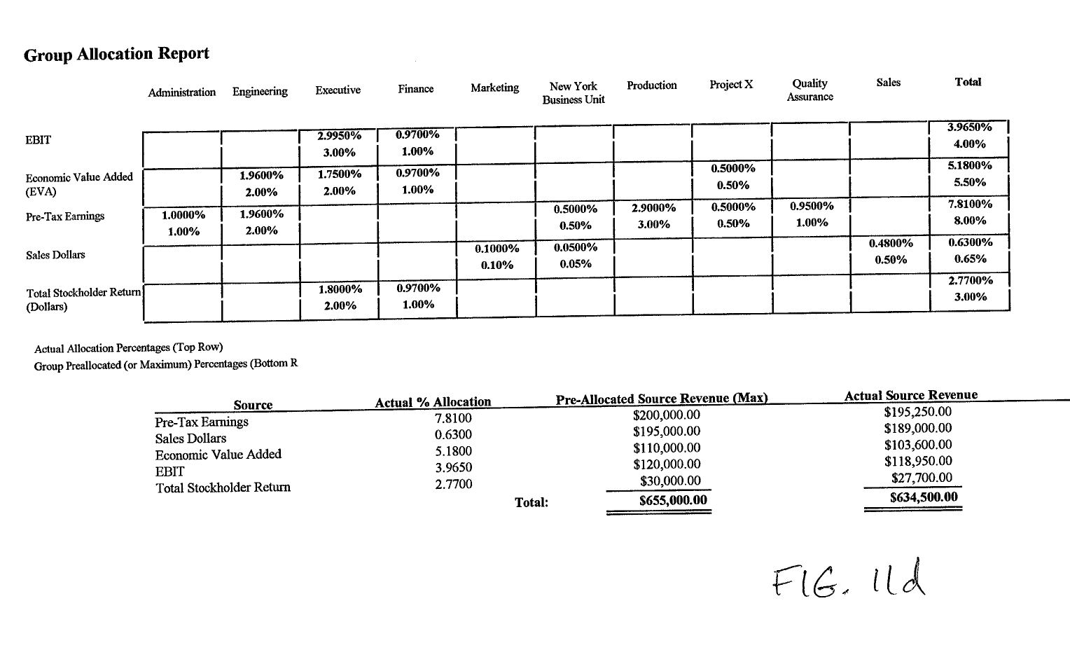

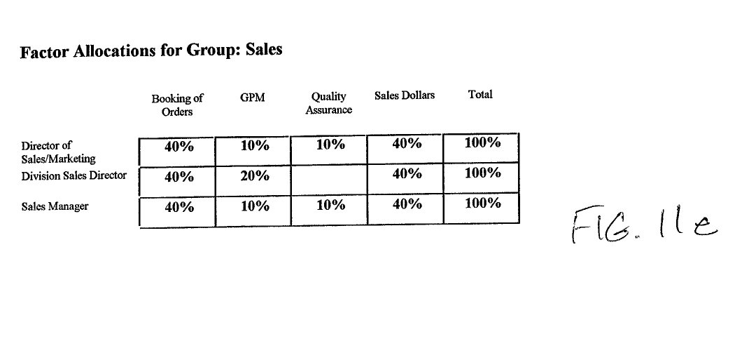

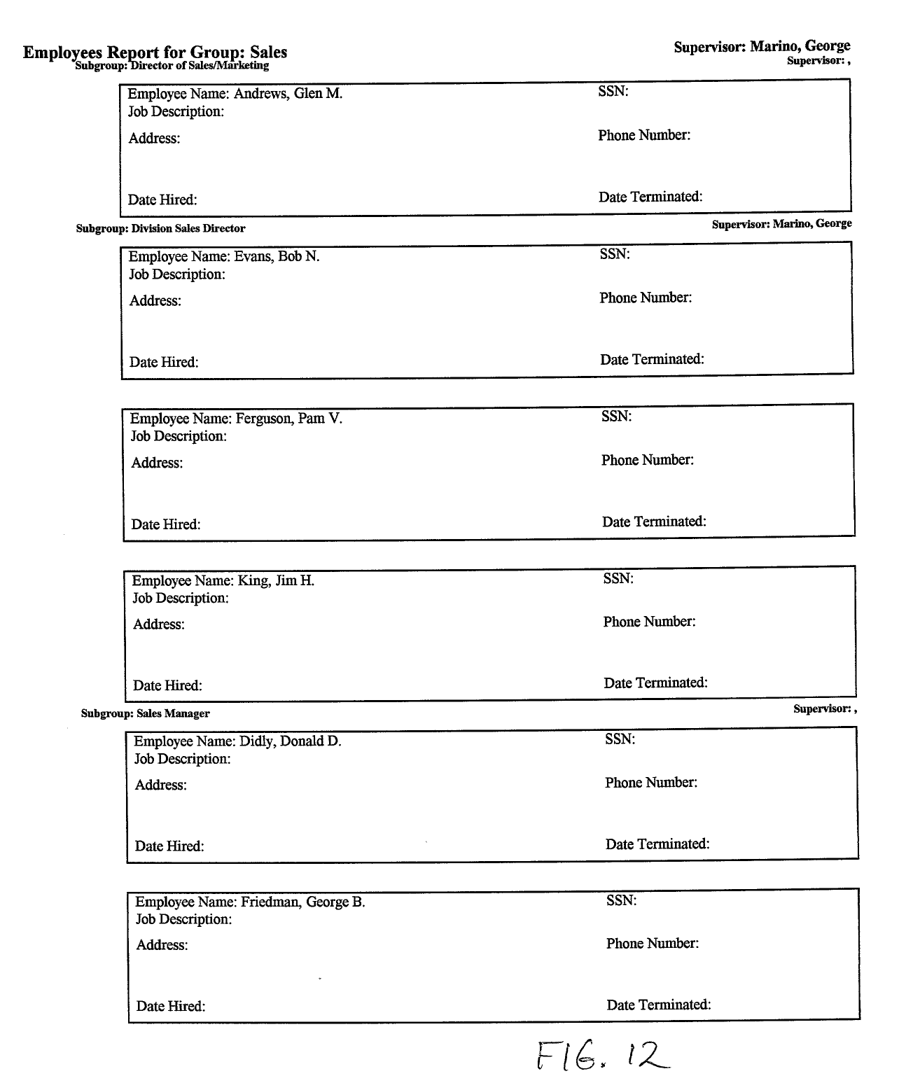

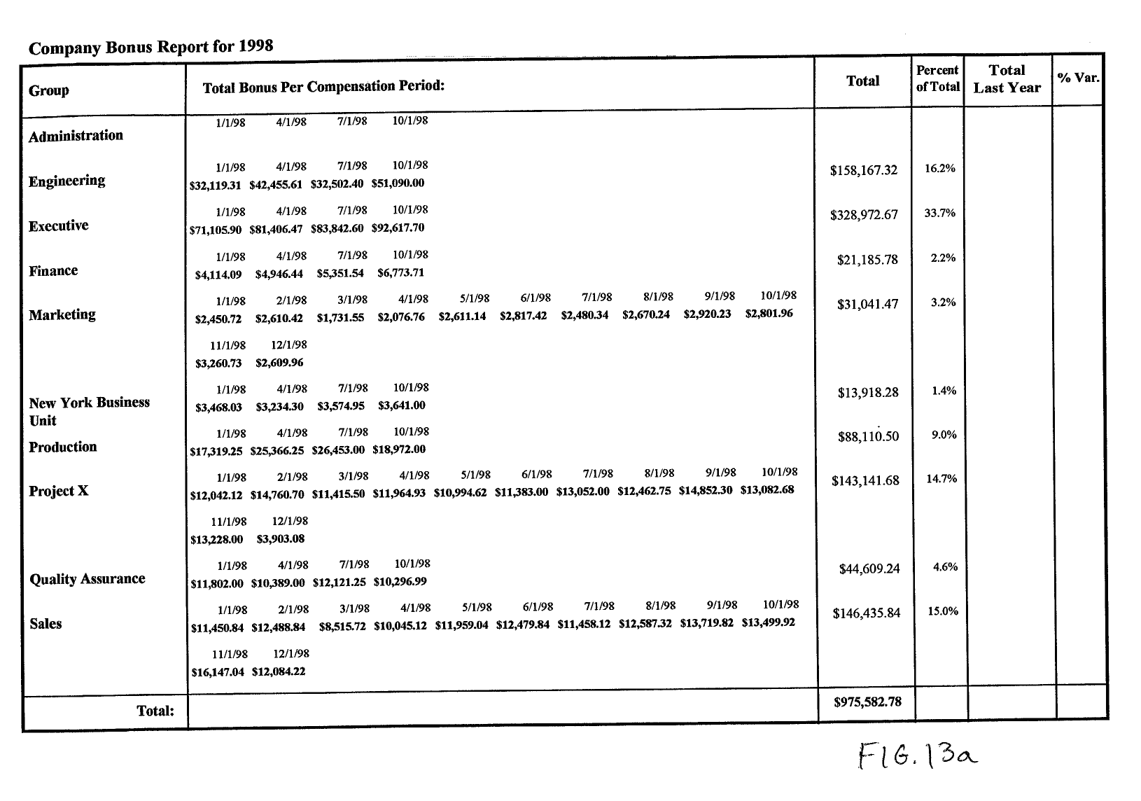

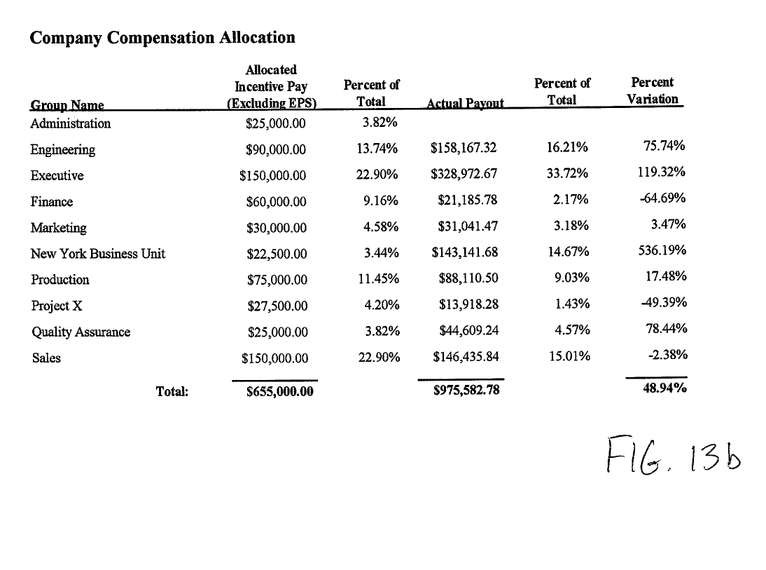

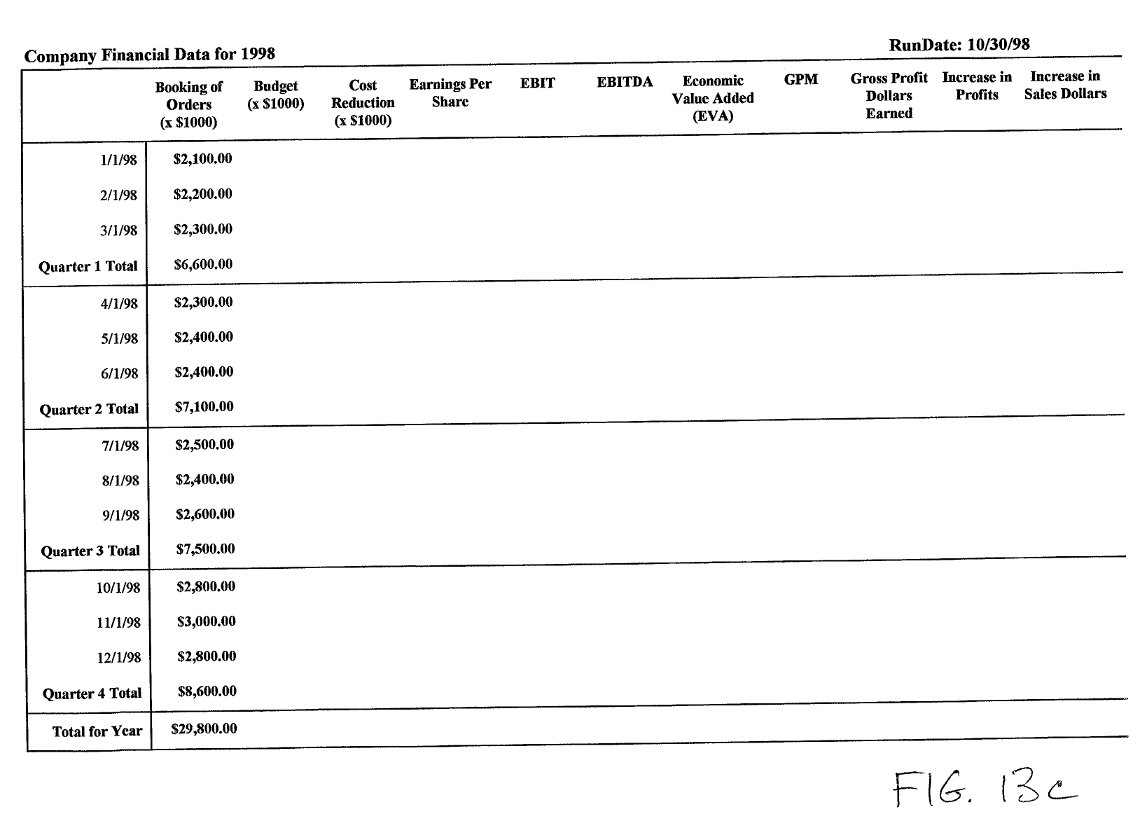

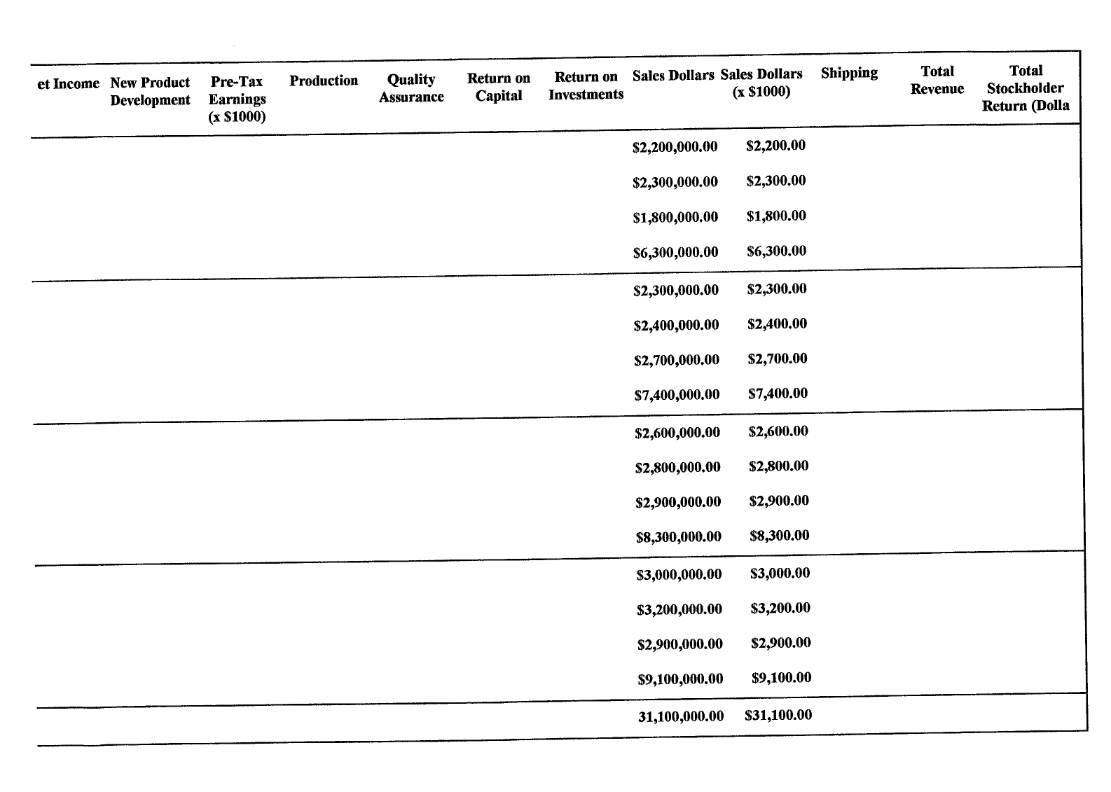

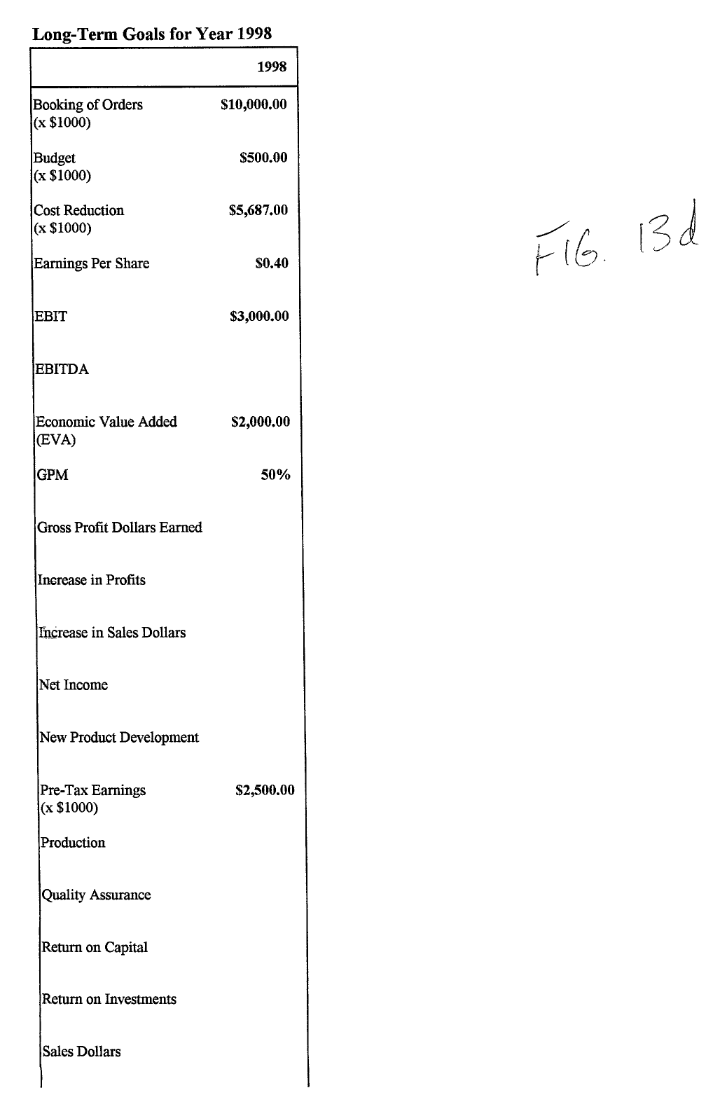

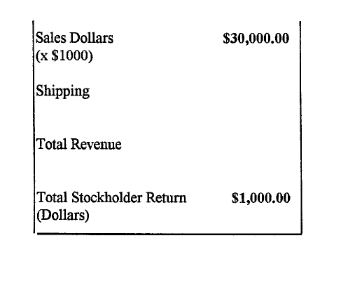

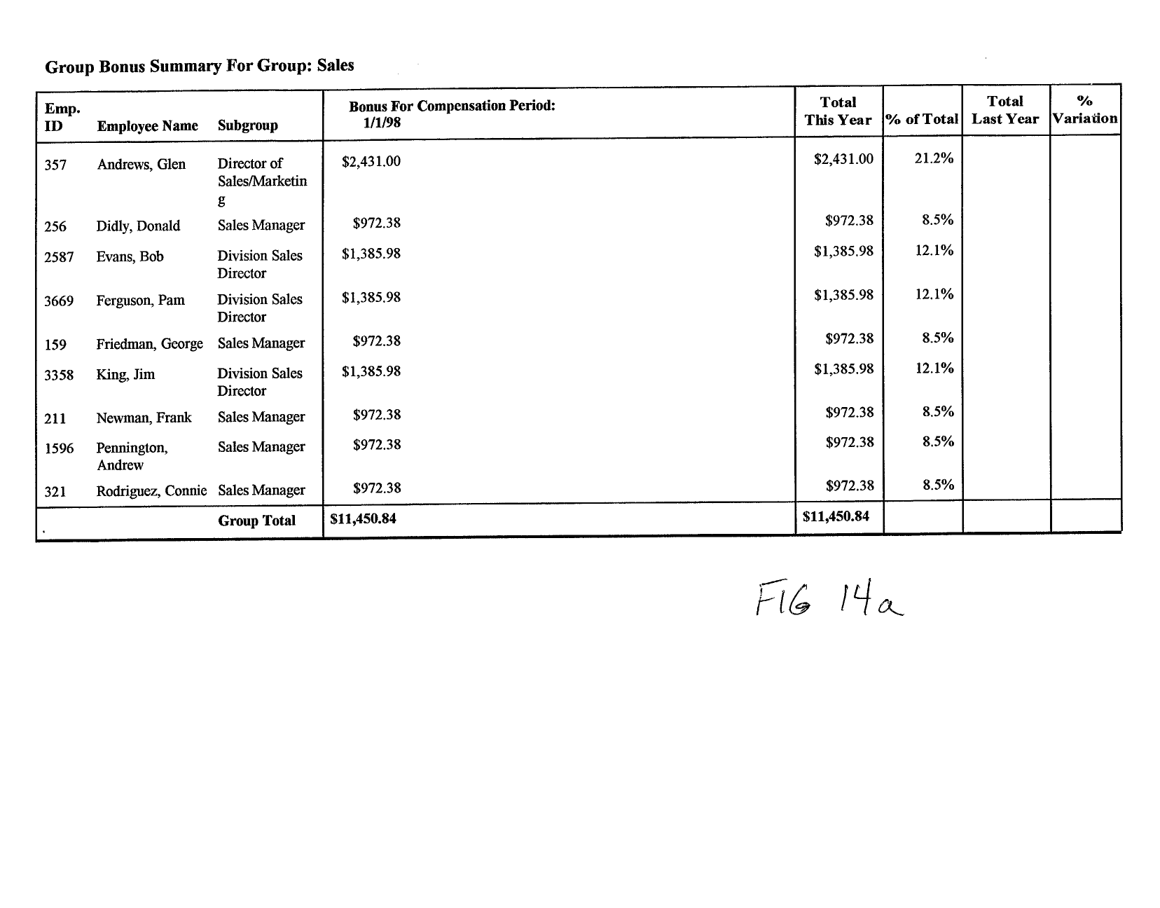

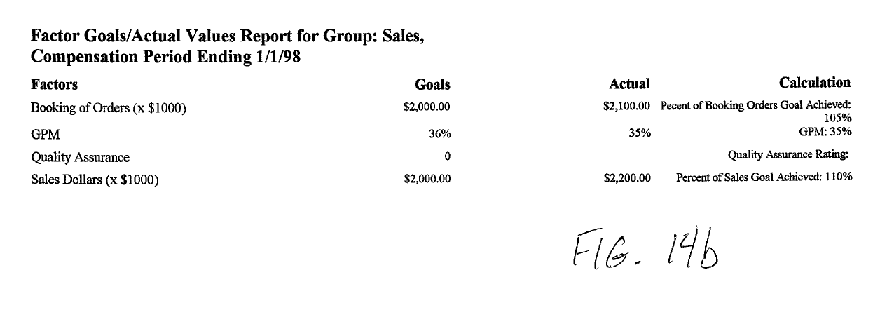

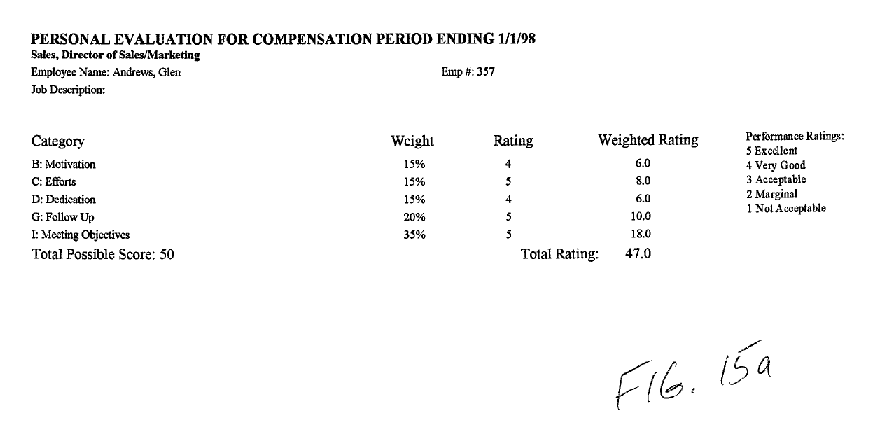

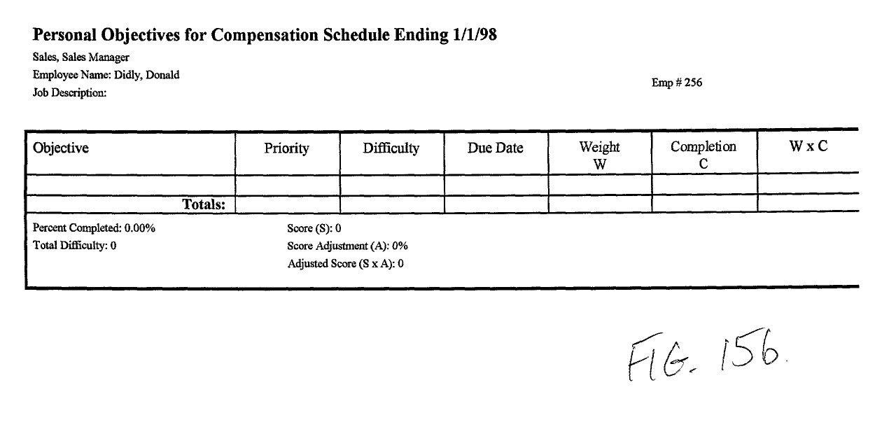

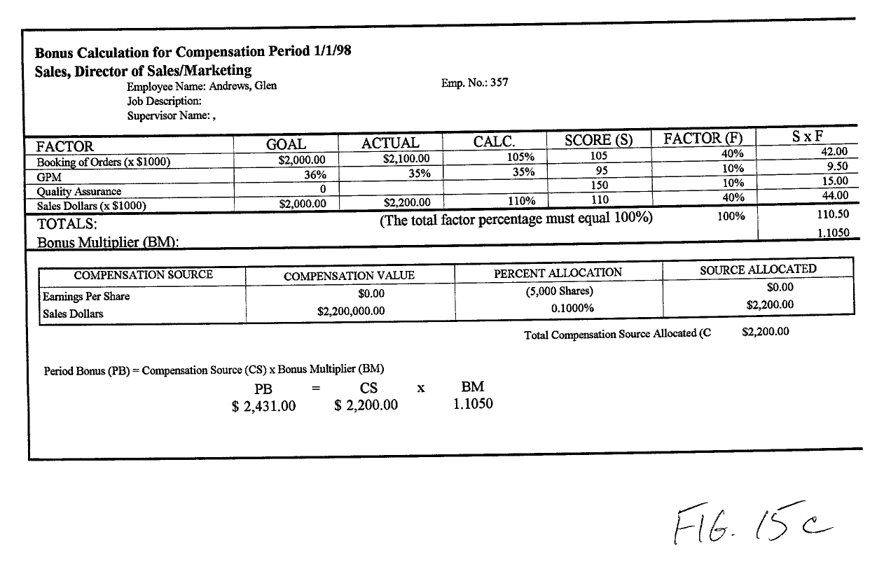

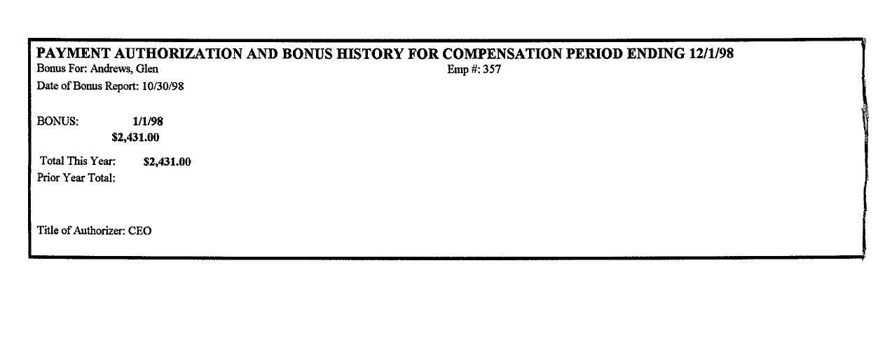

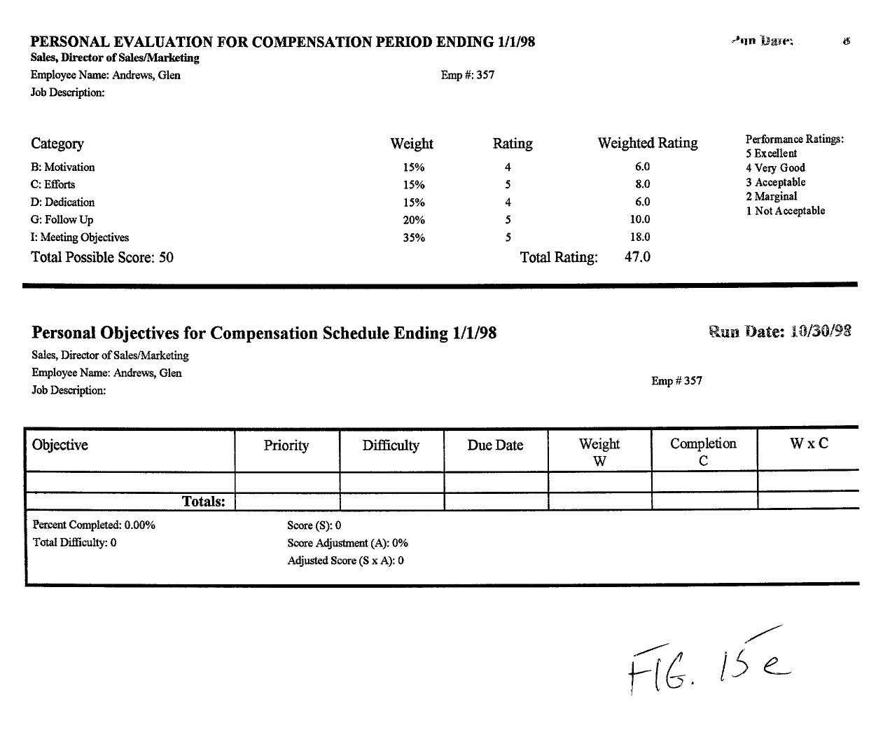

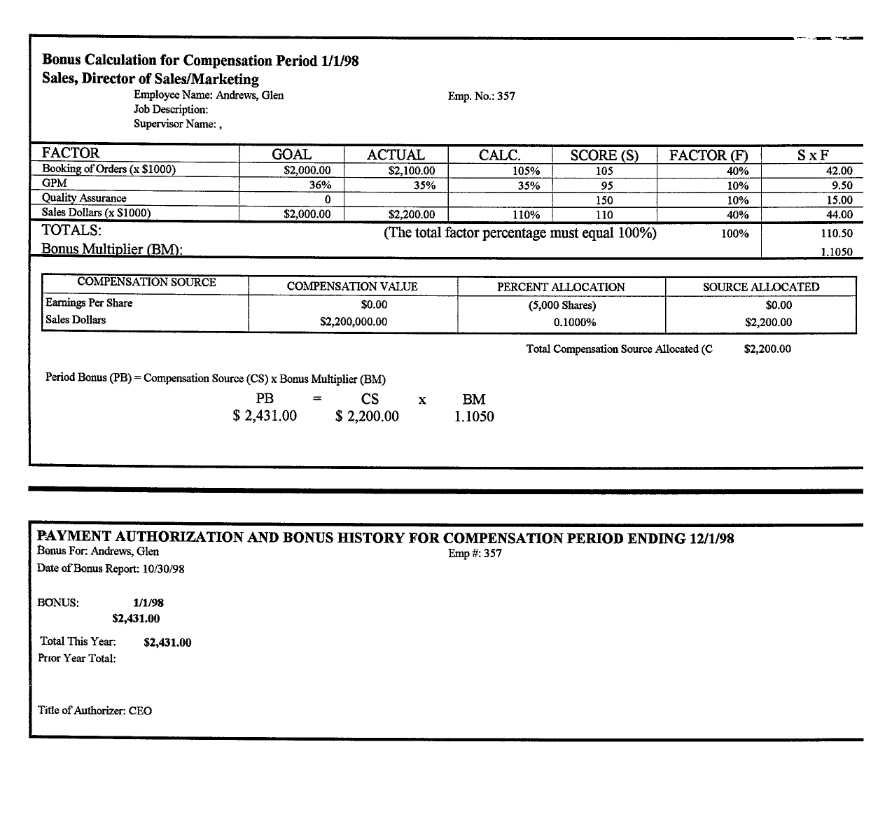

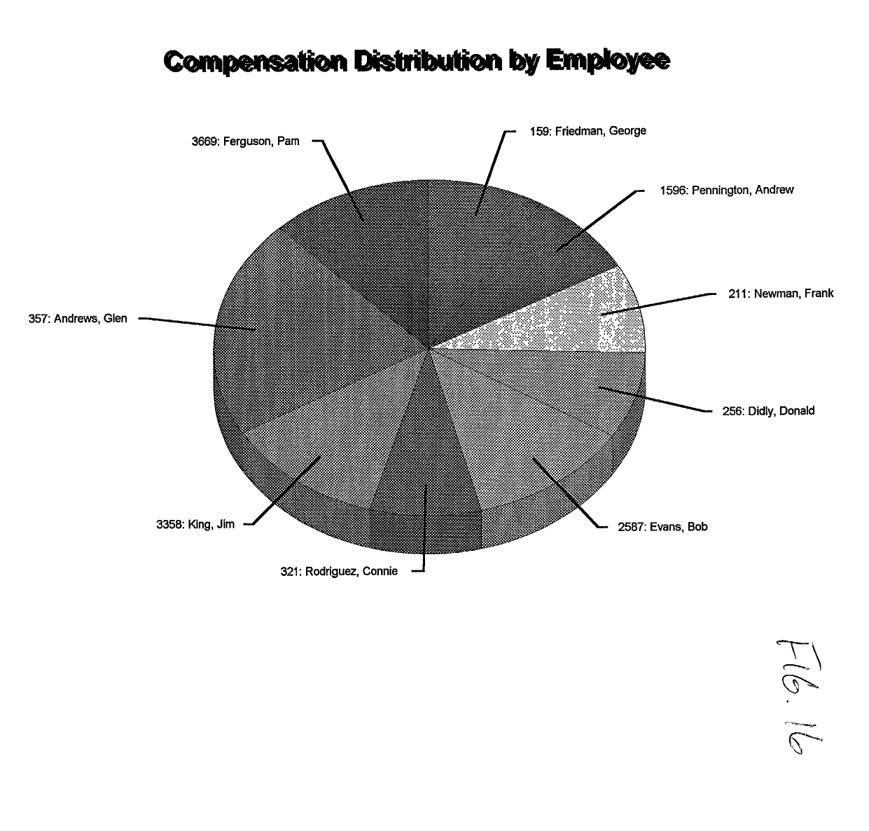

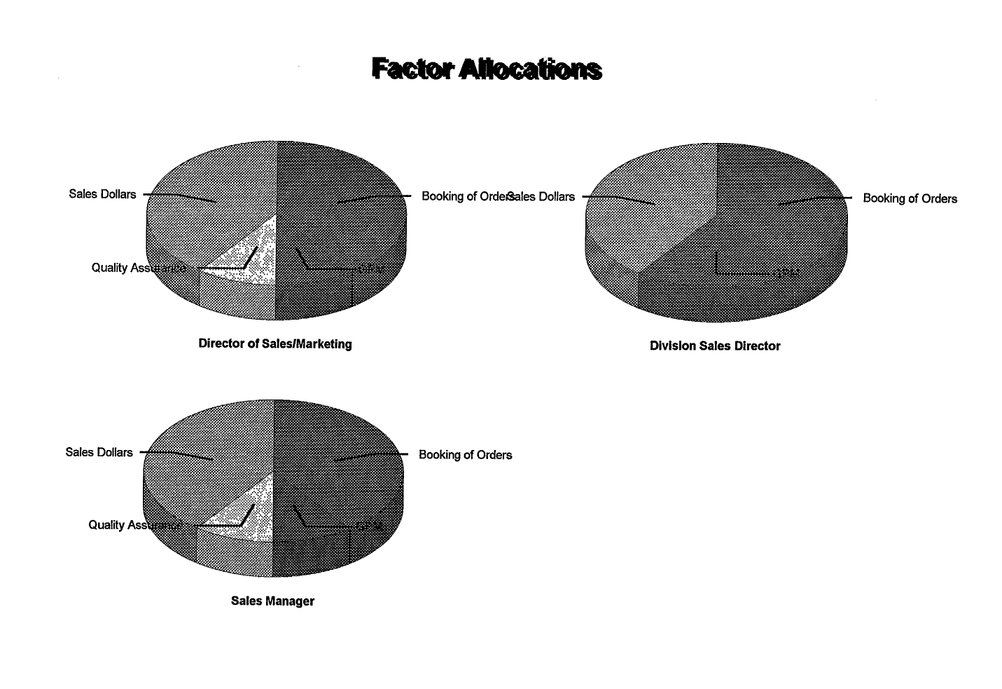

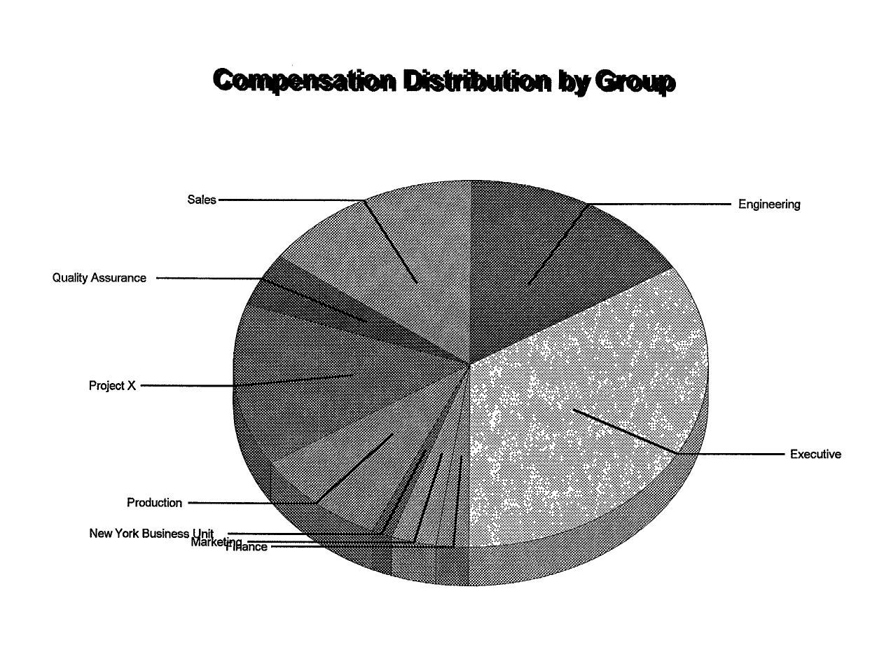

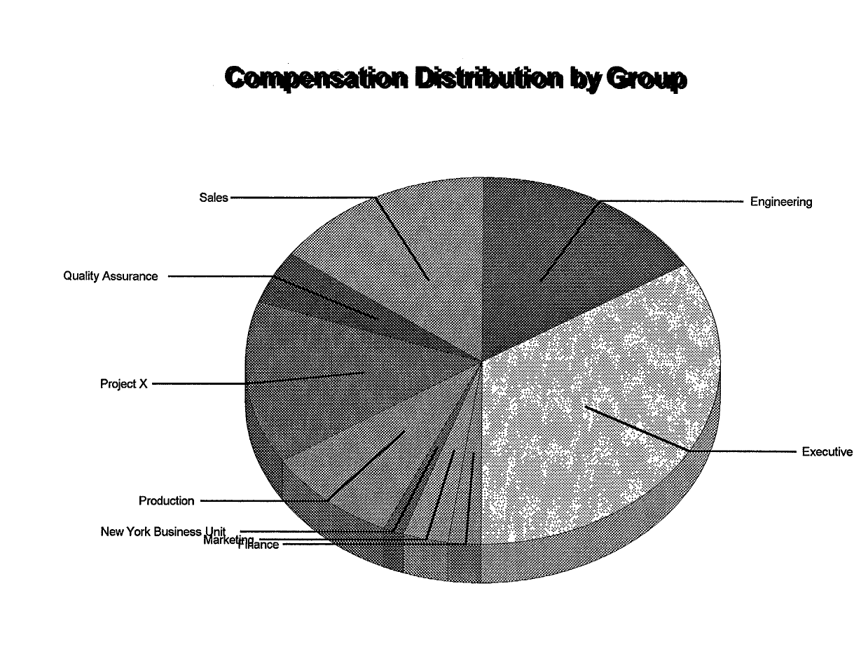

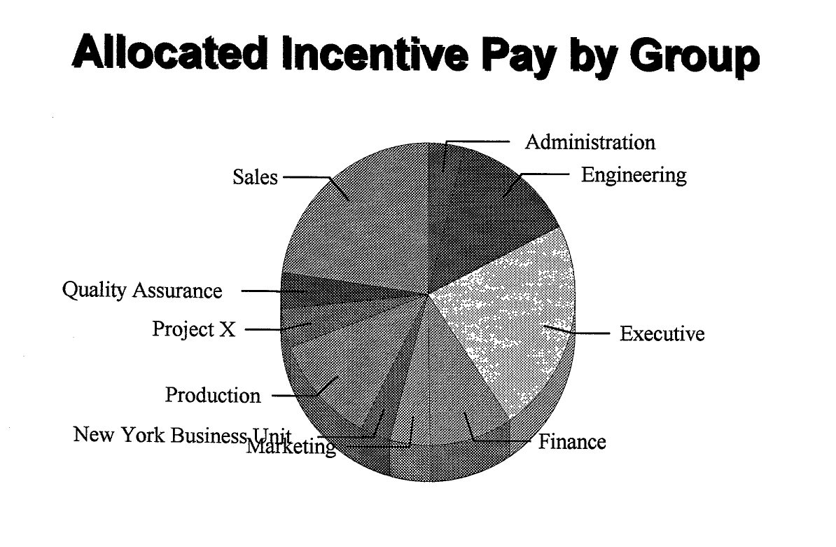

The invention has five categories of reports, four of which are accessible by the Group Administrator. These reports are: Setup Reports, Employees Report, Group Summary Reports, and Employee Bonus Reports. Samples of these reports are provided as FIGS. 11-15. All of these reports are accessed and utilized in the same manner. A description of the available reports (by category) follows the procedure. In the Employee Bonus Reports category, the Combined Report is simply a compilation of the Employee Evaluation, Employee Personnel Objective, and Employee Bonus Calculation Reports covered in Employee Privileges. The Bonus Authorization and History Report has additional procedural and functional significance.

The Setup Reports include the following reports. The Group/Factors report displays information input during the Setup of Incentive Factors. The report lists groups assigned to the Group Administrator in the left-hand column and Incentive Factors assigned to those groups as column headings. An “X” at the intersection of the two indicates that the factor is assigned to the group. The Factors/Scores Report displays information by group from the Score Tables and Personal Objective Score Adjustments. The Subgroup/Employee Allocation Report displays the Compensation Allocation input in the Setup portion of the program The Factor Allocation report reflects data input in the Factor procedure.

The Employees Report reflects entries by group/subgroup in the Employees Setup section.

The Group Summary Reports include the Group Summary Bonus Report which displays the bonus compensation for all the employees in a selected group for a selected period. It also totals the bonus compensation for the current year and compares it with the previous year's compensation (if available). The Factor Goals/Actual Values Report displays target goals by factor and the actual values achieved. It also compares the goal and actual values as a percent achieved.

The Employee Bonus Report reports employee bonuses.

From the foregoing description it is clear that the present invention provides numerous benefits over prior benefit systems. For example, incentive rewards are directly linked to the financial performance of the organization. It is calculated as a percentage of one or several financial benchmarks, including but not limited to pretax profits, gross profit dollars earned, sales dollars, increase in sales dollars, increase in profit dollars, economic value added (EVA), earnings per share (EPS), etc.

Additionally, each participant is assigned a piece of the total award pie depending on the importance of their role and contribution to the organization. The invention creates main employee groups and subgroups from your organization chart or build special teams assigned to specific tasks or projects. Incentive factors are tools or means through which the organization can achieve its long term strategic goals. They are identified by closely reviewing the long term goals and determining the most critical elements essential to achieving them. Employee groups, teams, and individuals are compared to the incentive factors selected and are assigned the ones they have the most influence and impact on. Each factor assigned is then designated a weight based on its importance within the group in relation to reaching the set goals. Goal attainment is measured by comparing actual periodic results to the set goals. Measurements are made at all levels of the corporate structure. For each group a regular payout schedule can be selected from bi-weekly to monthly, quarterly, semi-annually, or annually. Corporate executives, department managers, and supervisors have instant access to all the performance and incentive compensation data for the groups which fall under their corporate responsibility.

The invention ensures that participants can only review the data designated as accessible to them and cannot access other program confidential parameters or data. All calculations related to incentive payout are fully automated. Detailed performance, incentive pay statements and reports are easily generated for individuals, teams, groups, or the whole company. Managers and supervisors can conduct reviews face to face on-line with their group members. They review personal performance, goal attainment, incentive reward and receive feedback from their members on areas that need improvement, suggestions on how to improve productivity and enhance profitability.

While the invention has been described with references to various embodiments, the description is illustrative and is not to be construed as limiting the scope of the invention. Various modifications and changes may occur to those skilled in the art without departing from the spirit and scope of the invention as defined by the appended claims.

What is claimed is:

1. A system for design and implementation of an employee incentive and compensation plan for a business, comprising:
a series of computer programs for enabling a user of the programs to modify preset structures of the computer programs according to parameters determined by the user, wherein the preset structures include an Employee Group structure, Incentive Factor Score Table structures, a Factor Percent Allocation of Incentive Factors to Employee Groups structure, and a Profit Allocation to Employee Groups structure, wherein the series of computer programs accept data input from the user and generate outputs based on the preset structures and the data input, said outputs including periodic employee bonuses.

2. The system according to claim 1, wherein said parameters determined by the user include Employee Groups, Incentive Factors, Factor Percent Allocations, and Profit Allocations.

3. The system according to claim 1, wherein the data input from the user includes employee data and business financial data.

4. The system according to claim 1, wherein said Incentive Factor Score Table structures include increments of a set goal or rating and an associated score for each increment.

5. A computer software system for an automated employee incentive and compensation plan, comprising:
a first means for incentive plan design and implementation which enable functions to be performed by a system user including setting up an incentive program, entering program data, and automating periodic employee bonus calculations based on the incentive program and program data.

6. The system according to claim 5, further comprising:
a second means for generating an employee survey from a preset questionnaire structure.

7. The system according to claim 6, wherein said second software tool includes means for compiling, analyzing, and outputting results gathered by said employee survey.

8. The system according to claim 7, wherein a complied result includes a Survey Index which allows for comparison of an initial employee survey with a successive employee survey.

9. The system according to claim 5, wherein the first software tool includes structures for setting up the incentive program, wherein said structures include an Employee Group structure, Incentive Factor Score Table structures, a Factor Percent Allocation of Incentive Factors to Employee Groups structure, and a Profit Allocation to Employee Groups structure.

10. The system according to claim 9, wherein said structures are adapted to be customized by the user.

11. The system according to claim 10, wherein said first software tool integrates program data with said structures to generate said periodic employee bonus calculations.

12. The system according to claim 5, wherein said first software tool further includes means for analyzing, compiling and outputting said program data and said periodic employee bonus calculations.
